(19) United States
(12) Patent Application Publication
(10) Pub. No.: US 2012/0013720 A1
(43) Pub. Date: Jan. 19, 2012

(54) DISPLAY DEVICE

(76) Inventors: Shinichi Kadowaki, Kumamoto (JP); Shinichi Shikii, Nara (JP)

(21) Appl. No.: 13/181,805

(22) Filed: Jul. 13, 2011

Related U.S. Application Data
(60) Provisional application No. 61/364,086, filed on Jul. 14, 2010.

(51) Int. Cl. H04N 13/04

(52) U.S. Cl. 348/58; 348/E13.026

(57) ABSTRACT

A display device is provided with an image display portion for temporally switching a left frame image to be viewed by a left eye, and a right frame image to be viewed by a right eye to emit video light so that a video is stereoscopically perceived; a light deflector for deflecting the video light emitted from the image display portion; and a controller for controlling the light deflector to adjust a deflection direction of the video light output from the light deflector. The image display portion changes polarization characteristics of the video light area by area, and the light deflector deflects the video light in response to the polarization characteristics so that the video light of the left frame image is incident to the left eye and the video light of the right frame image is incident to the right eye.

### RELATED APPLICATIONS

This application claims priority on U.S. Preliminary Patent Application No. 61/364,086 (application date Jul. 14, 2010).

### BACKGROUND OF THE INVENTION

1. Field of the Invention

The present invention is related to a display device for displaying a video to be stereoscopically perceived.

2. Description of the Background Art

In recent years, various display devices have widely used to display a video. For example, plasma display panels which use plasma light emission to display a video, organic EL display devices which display a video by means of electroluminescence, and liquid crystal display panels which display a video by means of transmittance change of liquid crystals to adjust a transmitted light amount from a backlight source are exemplified as the display devices. Technologies have been also developed to use these display devices for causing a video to be stereoscopically perceived by viewers.

Various principles have been proposed to make a video stereoscopically perceived. A parallax barrier methodology is exemplified as one of the proposed display technologies (for example, see U.S. Pat. No. 5,264,964).

FIG. 11 is a schematic view showing principles of the stereoscopic video display according to the conventional parallax barrier methodology. The principles of the stereoscopic video display according to the conventional parallax barrier methodology are described with reference to FIG. 11

A display device 900 is schematically shown in FIG. 11. The display device 900 is provided with an image display portion 910 configured to display a video, a backlight source 920 configured to irradiate light toward the image display portion 910, and a parallax barrier portion 930 which is situated between a viewer and the image display portion 910.

According to the conventional parallax barrier methodology, the image display portion 910 simultaneously displays a left eye video to be viewed by the left eye, and a right eye video to be viewed by the right eye. In FIG. 11, regions of the image display portion 910, to which the symbol “R” is assigned, represent pixels configured to display the right eye video. Regions of the image display portion 910, to which the symbol “L” is assigned, represent pixels configured to display the left eye video.

The parallax barrier portion 930 separates the light of the left eye video and the light of the right eye video from each other. As a result, the light of the left eye video is incident to only the left eye whereas the light of the right eye video is incident to only the right eye. The viewer perceives a parallax between the left and right eye videos to stereoscopically view the video displayed by the display device 900.

According to the display technologies on the basis of the parallax barrier methodology described with reference to FIG. 11, the parallax barrier portion 930 includes a member (for example, a black dye or metal) configured to block transmission of visible light so that the light of the left eye video and the light of the right eye video are separated from each other. The parallax barrier portion 930 blocks a part of the light from the image display portion 910, which results in a less luminous video viewed by the viewer.

### SUMMARY OF THE INVENTION

An object of the present invention is to provide a display device for displaying a highly luminous video to be stereoscopically perceived by means of the parallax barrier methodology.

A display device according to one aspect of the present invention is provided with an image display portion which temporally switches between a left frame image to be viewed by a left eye and a right frame image to be viewed by a right eye to emit video light so that a video is stereoscopically perceived; a light deflector configured to deflect the video light emitted from the image display portion; and a controller which controls the light deflector to adjust a deflection direction of the video light output from the light deflector, wherein the image display portion changes polarization characteristics of the video light area by area, and the light deflector deflects the video light in response to the polarization characteristics.

The aforementioned display device may display a highly luminous video to be stereoscopically perceived by means of the parallax barrier methodology.

Objects, features and advantages of the present invention will become apparent through the following detailed descriptions and accompanying drawings.

### BRIEF DESCRIPTION OF THE DRAWINGS

FIG. 1 is a schematic view of a display device according to one embodiment;

FIG. 2 is a schematic block diagram of the display device shown in FIG. 1;

FIG. 3 is a schematic view showing optical paths of video light from an image display portion of the display device shown in FIG. 1, which displays a right frame image;

FIG. 4 is a schematic view showing other optical paths of the video light from the image display portion of the display device shown in FIG. 1, which displays the right frame image;

FIG. 5 is a schematic view showing yet other optical paths of the video light from the image display portion of the display device shown in FIG. 1, which displays the right frame image;

FIG. 6 is a schematic view showing yet other optical paths of the video light from the image display portion of the display device shown in FIG. 1, which displays the right frame image;

FIG. 7 is a schematic view showing optical paths of the video light from the image display portion of the display device shown in FIG. 1, which displays a left frame image;

FIG. 8 is a schematic view showing other optical paths of the video light from the image display portion of the display device shown in FIG. 1, which displays the left frame image;

FIG. 9 is a schematic view showing yet other optical paths of the video light from the image display portion of the display device shown in FIG. 1, which displays the left frame image;

FIG. 10 is a schematic view showing yet other optical paths of the video light from the image display portion of the display device shown in FIG. 1, which displays the left frame image; and

FIG. 11 is a schematic view showing principles of stereoscopic video display according to the conventional parallax barrier methodology.

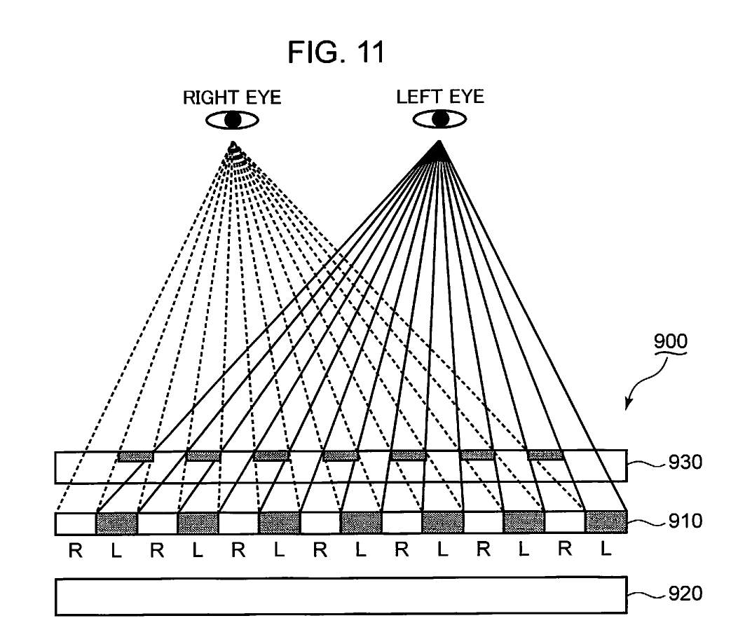

### DESCRIPTION OF THE PREFERRED EMBODIMENTS

Hereinafter, a display device according to one embodiment is described with reference to the accompanying drawings. It should be noted that identical symbols are assigned to identical structural elements in the embodiment described hereinafter. Repetitive descriptions are omitted as appropriate so as to make the descriptions clear. Configurations, arrangements and shapes shown in the drawings as well as the descriptions relating to the drawings are merely for facilitating to make principles of the display device understood. Therefore the principles of the display device are not limited to these.

### <Configuration of Display Device>

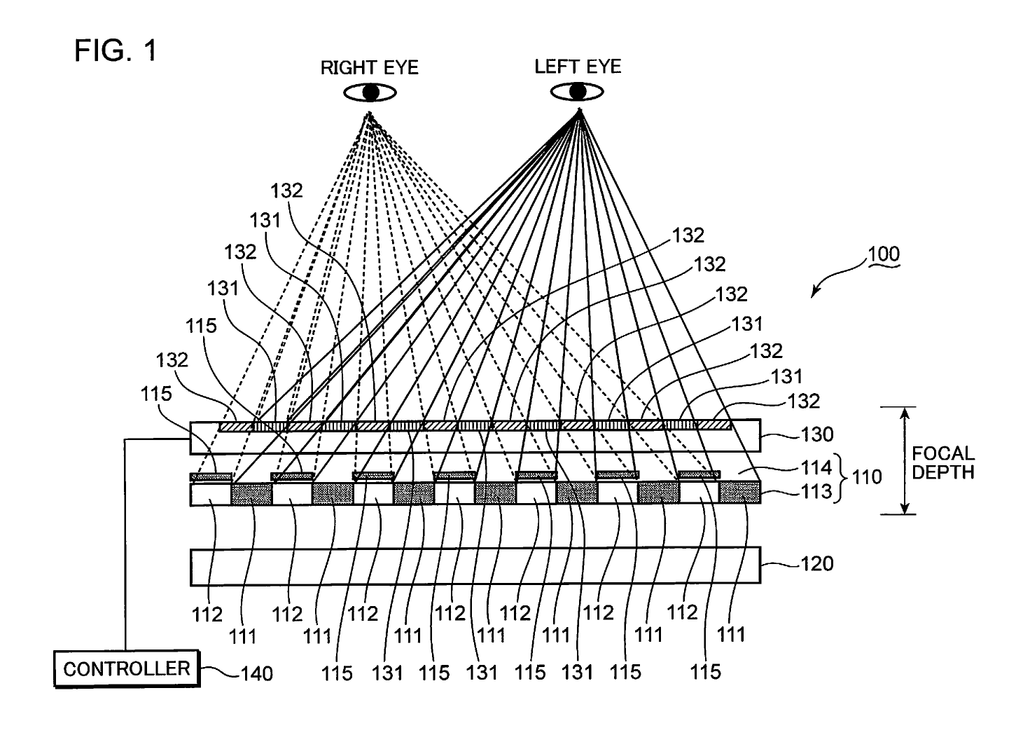

FIG. 1 is a schematic view of a display device 100. The display device 100 is described with reference to FIG. 1.

The display device 100 is provided with an image display portion 110 configured to temporally switch between a left frame image to be viewed by the left eye and a right frame image to be viewed by the right eye. The left frame image represents different contents by an amount of parallax from the right frame image. The viewer perceives the parallax between the left and right frame images to stereoscopically view the video displayed by the image display portion 110.

Unlike the aforementioned conventional technologies, after one of the left and right frame images is displayed over the entire surface of the image display portion 110, the other frame image is displayed over the entire surface of the image display portion 110. For example, the switching frequency of the frame image display is from 96 Hz to 120 Hz.

The display device 100 is further provided with a backlight source 120 configured to irradiate light toward the image display portion 110. The image display portion 110 uses liquid crystals to adjust transmittance of the light from the backlight source 120, so that the image display portion 110 displays the left and right frame images. In the present embodiment, the display device 100 displays a video by means of liquid crystals. Alternatively, the display device may display video by means of elements configured to emit light themselves like plasma display panels and organic EL display devices. In a case of a display device with the self-emitting elements, the backlight source may be omitted.

The image display portion 110 is provided with an emitting portion 113 configured to emit video light corresponding to the left or right frame image. The emitting portion 113 includes first pixel regions 111 and second pixel regions 112. The first and second pixel regions 111, 112 are horizontally aligned. As described above, the first and second pixel regions 111, 112 cooperatively work to emit video light of the entire frame image, respectively.

The left eye and the right eye of a viewer are shown in FIG. 1. In the following descriptions, the direction in which the viewer is present is referred to as “front.” The direction in which the backlight source 120 is present is referred to as “rear”. These directional words are used to clarify the descriptions and do not in any way limit the principles of the present embodiment.

The image display portion 110 is further provided with a polarization rotation portion 114, which is situated in front of the emitting portion 113. The polarization rotation portion 114 includes several polarization rotation devices 115, which are situated in front of the second pixel regions 112, respectively.

In the present embodiment, the video light output from the emitting portion 113 is p-polarization. The polarization rotation devices 115 rotate the polarization direction of the p-polarization video light to generate s-polarization. In the present embodiment, the polarization rotation devices 115 are exemplified as the polarization rotation elements.

The polarization rotation devices 115 and the corresponding second pixel regions 112 are horizontally aligned discretely at constant intervals. Accordingly, the light (video light) which passes through the image display portion 110 includes p-polarization and s-polarization that are alternately aligned at constant intervals.

In the present embodiment, the p-polarization is exemplified as the first polarized light. The s-polarization is exemplified as the second polarized light. Alternatively, the polarization rotation elements may be arranged in correspondence with the first pixel regions. In this case, the p-polarization is exemplified as the second polarized light while the s-polarization is exemplified as the first polarized light. Further alternatively, the video light output from the emitting portion 113 may be s-polarization. In this case also, the p-polarization is exemplified as the second polarized light while the s-polarization is exemplified as the first polarized light.

In the present embodiment, the first pixel regions 111 are exemplified as the first display areas. The regions, which include the second pixel regions 112 and the polarization rotation devices 115, are exemplified as the second display areas. Alternatively, if the polarization rotation elements are arranged in correspondence with the first pixel regions, the first pixel regions are exemplified as the second display areas while the second pixel regions are exemplified as the first display areas.

The display device 100 is further provided with a parallax barrier portion 130 configured to deflect the video light emitted from the image display portion 110, and a controller 140 configured to control the parallax barrier portion 130. In the present embodiment, the parallax barrier portion 130 is exemplified as the light deflector.

The parallax barrier portion 130 includes first deflection regions 131 and second deflection regions 132. The first and second deflection regions 131, 132 are alternately and horizontally aligned. The arrangement pattern of the first and second deflection regions 131, 132 corresponds to the aforementioned arrangement pattern of the polarization rotation devices 115.

The controller 140 electrically controls deflection characteristics of the first and second deflection regions 131, 132. In the present embodiment, liquid crystal elements are situated in the first and second deflection regions 131, 132. The controller 140 electrically adjusts refractive indices of the liquid crystal elements of the first and second deflection regions 131, 132 to change the deflection direction of the video light output from the parallax barrier portion 130. Alternatively, the controller may adjust deflection characteristics of the video light in accordance with any other methods.

Brazed holograms formed from liquid crystal materials are layered on the first and second deflection regions 131, 132. The controller 140 may separately adjust the refractive indices of the first and second deflection regions 131, 132. The diffractive properties of the brazed gratings of the brazed hologram vary in response to a voltage applied under the control of the controller 140. For example, if a magnitude “V1” of the voltage is applied to the brazed hologram, the brazed hologram diffracts p-polarization of the video light whereas the brazed hologram allows s-polarization of the video light to pass through without diffraction. If a magnitude “V2” of the voltage is applied to the brazed hologram, the brazed hologram diffracts s-polarization of the video light whereas the brazed hologram allows p-polarization of the video light to pass through without diffraction.

In the present embodiment, brazed holograms are layered on the first and second deflection regions 131, 132, respectively. Therefore, the controller 140 may independently control the deflection direction of the incident light (video light) with two different polarizations (p-polarization and s-polarization). As aforementioned, the image display portion 110 uses the polarization rotation devices 115 to vary the polarization characteristics of the video light area by area. If the parallax barrier portion 130 diffracts the video light or allows the video light to pass through under the control of the controller 140 in response to the polarization characteristics of the video light as described above, the light of the entire frame image enters as appropriate to the left or right eye. Accordingly, the viewer may view a highly luminous frame image. The control in response to the polarization characteristics is described later.

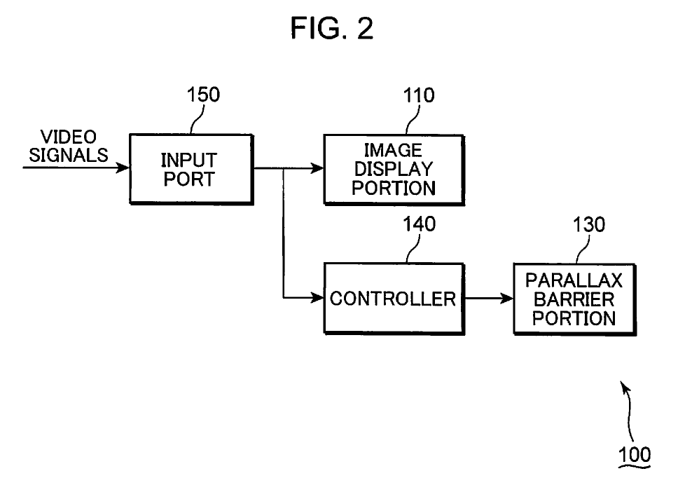

FIG. 2 is a schematic block diagram of the display device 100. The display device 100 is further described with reference to FIGS. 1 and 2.

The display device 100 is further provided with an input port 150, into which video signals are input, in addition to the image display portion 110, the controller 140 and the parallax barrier portion 130. The input port 150 converts and outputs the video signals into a predetermined format to the image display portion 110 and the controller 140. The signal conversion by the input port 150 allows the image display portion 110 and the controller 140 to read contents of the video signals.

For example, the image display portion 110 reads information about luminance and hue corresponding to each pixel from the video signals output from the input port 150. As a result, the first and second pixel regions 111, 112 of the image display portion 110 emit light at the luminance and the hue in response to the video signals. Thus, the image display portion 110 may display frame images.

For example, in response to the video signals from the input port 150, the controller 140 determines whether the displayed frame image on the image display portion 110 is a left or right frame image. The controller 140 controls the parallax barrier portion 130 according to the determination result.

### <Operation of Display Device>

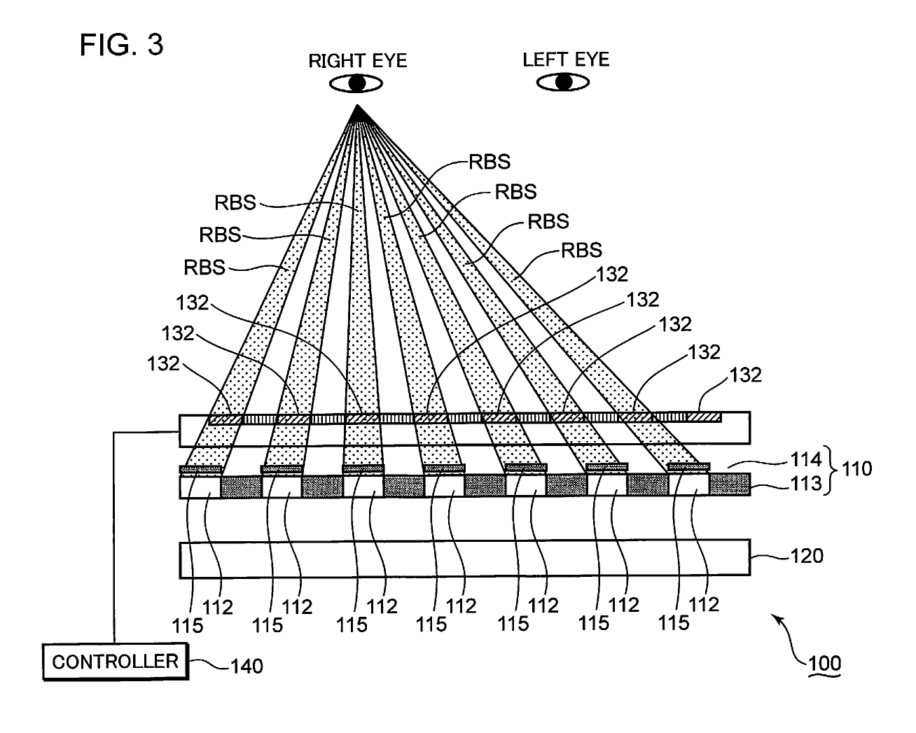

FIG. 3 is a schematic view showing optical paths of the video light from the image display portion 110, which displays a right frame image. Optical paths of the video light from the image display portion 110 which displays a right frame image are described with reference to FIG. 3.

FIG. 3 shows video light RBS of the right frame image, which is emitted from the second pixel regions 112. The video light RBS passes through the polarization rotation devices 115. As a result, the video light RBS becomes s-polarization.

The controller 140 applies the magnitude “V1” of the voltage to the second deflection regions 132. As a result, the second deflection regions 132 allow the video light RBS with s-polarization to pass through without diffraction. Accordingly, the video light RBS with the s-polarization linearly travels so that the video light RBS is incident to the right eye.

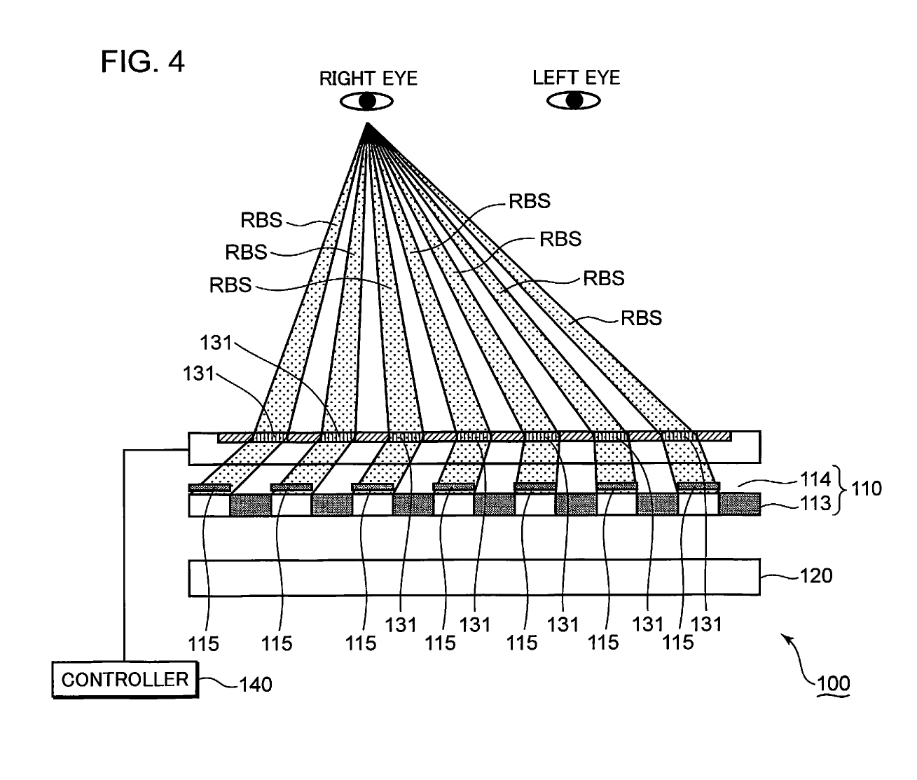

FIG. 4 is a schematic view showing other optical paths of the video light RBS from the image display portion 110, which displays the right frame image. The other optical paths of video light from the image display portion 110, which displays a right frame image, are described with reference to FIGS. 3 and 4.

As described with reference to FIG. 3, the video light RBS of the right frame image, which is emitted from the second pixel regions 112, passes through the polarization rotation devices 115 so that the video light RBS becomes s-polarization. Subsequently, the video light RBS is incident not only to the second deflection regions 132, but also to the first deflection regions 131.

The controller 140 applies the magnitude “V2” of the voltage to the first deflection regions 131. As a result, the first deflection regions 131 diffract the video light RBS with s-polarization toward the right eye. Accordingly, the video light RBS with s-polarization, which passes through the first deflection regions 131, is also incident to the right eye.

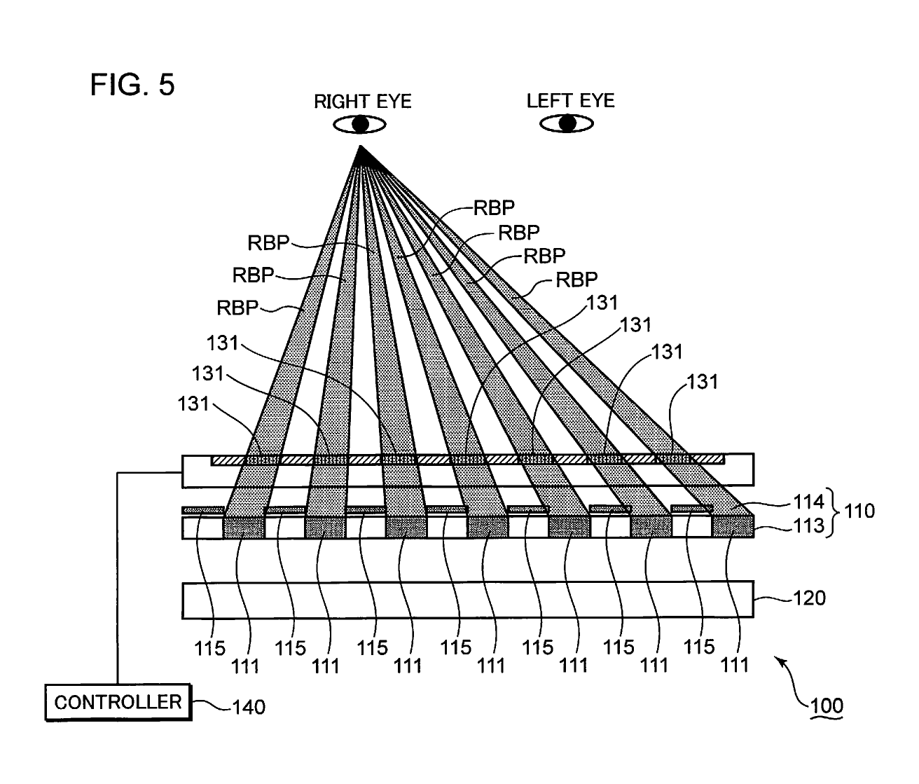

FIG. 5 is a schematic view showing yet other optical paths of the video light from the image display portion 110, which displays the right frame image. The other optical paths of the video light from the image display portion 110, which displays the right frame image, are described with reference to FIG. 5.

FIG. 5 shows video light RBP of the right frame image, which is emitted from the first pixel regions 111. The video light RBP is incident to the first deflection regions 131 without passing through the polarization rotation devices 115. As aforementioned, the emitting portion 113 emits p-polarization of the video light, so that the video light RBP, which is incident to the first deflection regions 131 from the first pixel regions 111, becomes p-polarization.

As aforementioned, the controller 140 applies the magnitude “V2” of the voltage to the first deflection regions 131. Meanwhile, the first deflection regions 131 allow passage of the video light RBP with p-polarization. Accordingly, the video light RBP with p-polarization linearly travels so that the video light RBP is incident to the right eye.

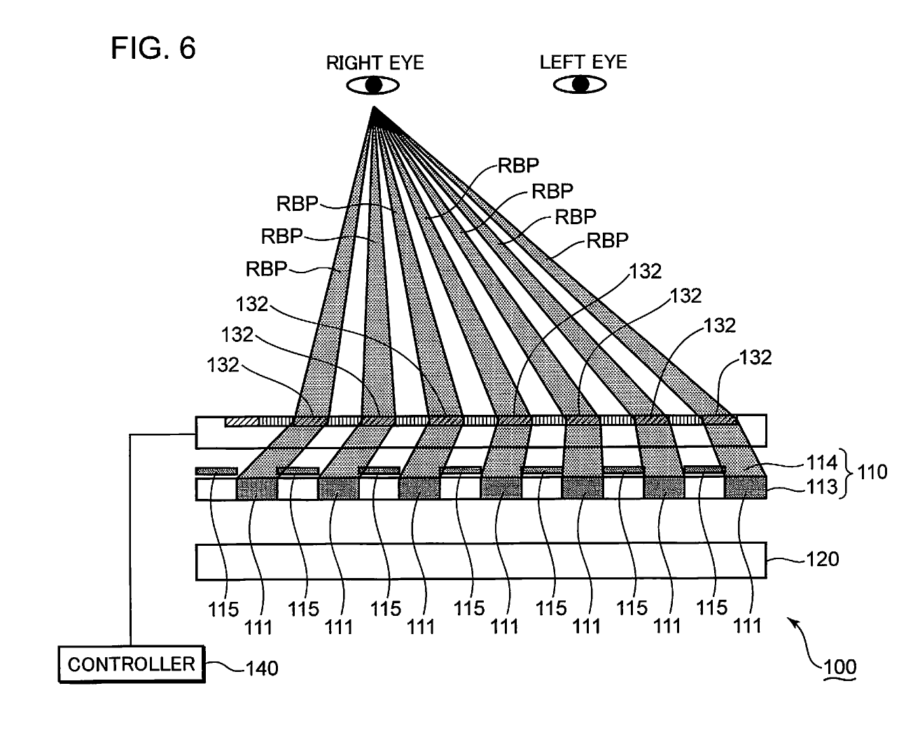

FIG. 6 is a schematic view showing other optical paths of the video light RBP from the image display portion 110, which displays the right frame image. The other optical paths of video light from the image display portion 110, which displays a right frame image, are described with reference to FIGS. 5 and 6.

The video light RBP of the right frame image, which is emitted from the first pixel regions 111, is incident to the second deflection regions 132 without passing through the polarization rotation devices 115. As aforementioned, the emitting portion 113 emits the p-polarization of the video light, so that the video light RBP, which is incident to the second deflection regions 132 from the first pixel regions 111, also becomes p-polarization.

As aforementioned, the controller 140 applies the magnitude “V1” of the voltage to the second deflection regions 132. Meanwhile, the second deflection regions 132 diffract the video light RBP with p-polarization toward the right eye. Accordingly, the video light RBP with p-polarization, which passes through the second deflection regions 132, is also incident to the right eye.

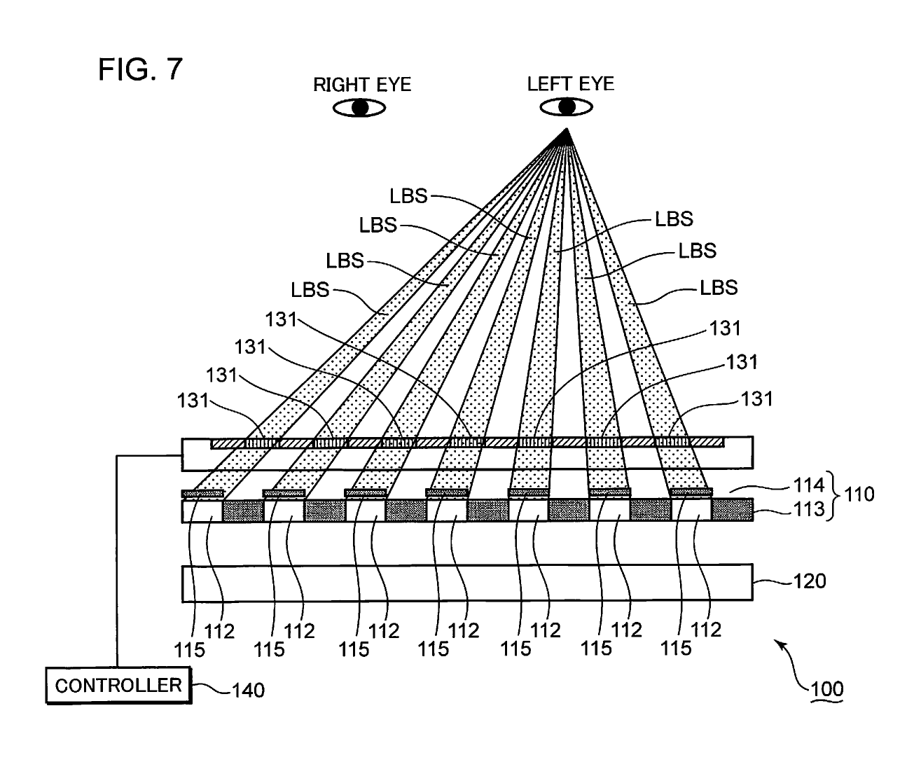

FIG. 7 is a schematic view showing optical paths of the video light from the image display portion 110, which displays a left frame image. The optical paths of the video light from the image display portion 110, which displays the left frame image, are described with reference to FIG. 7.

FIG. 7 shows video light LBS of the left frame image which is emitted from the second pixel regions 112. The video light LBS passes through the polarization rotation devices 115. As a result, the video light LBS becomes s-polarization.

The controller 140 applies the magnitude “V1” of the voltage to the first deflection regions 131. As a result, the first deflection regions 131 allow the video light LBS with s-polarization to pass through without diffraction. Accordingly, the video light LBS with s-polarization linearly travels so that the video light LBS is incident to the left eye.

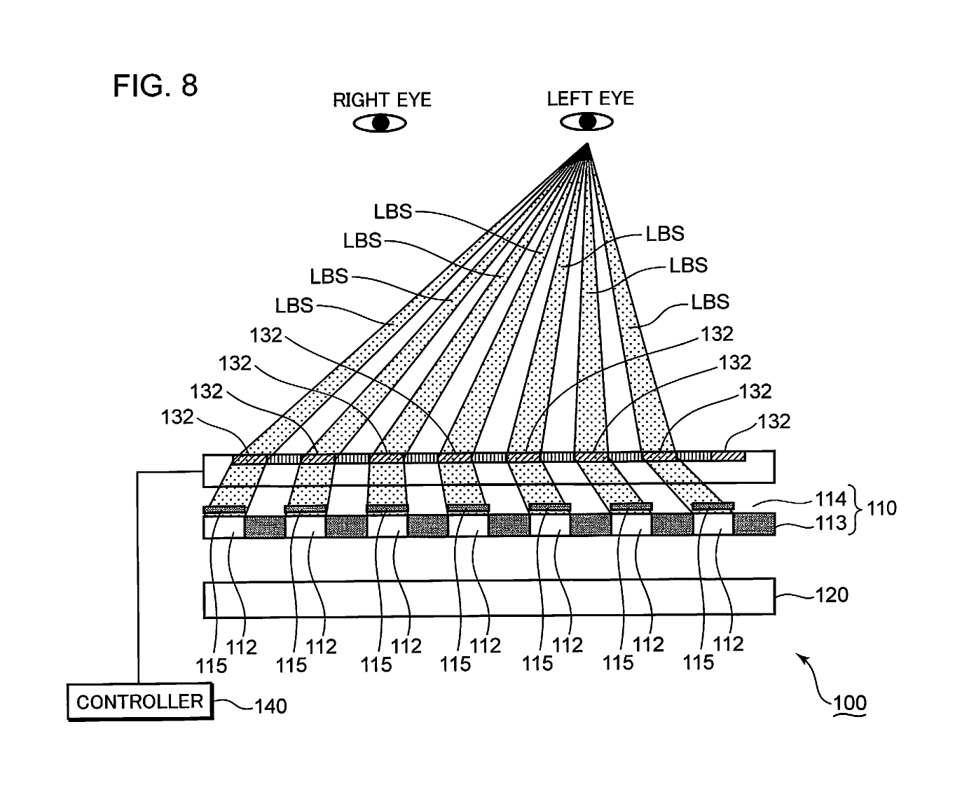

FIG. 8 is a schematic view showing other optical paths of the video light LBS from the image display portion 110, which displays the left frame image. The other optical paths of the video light from the image display portion 110, which displays the left frame image, are described with reference to FIGS. 7 and 8.

As described with reference to FIG. 7, the video light LBS of the left frame image, which is emitted from the second pixel regions 112 and passes through the polarization rotation devices 115, becomes s-polarization. Subsequently, the video light LBS is incident not only to the first deflection regions 131, but also to the second deflection regions 132.

The controller 140 applies the magnitude “V2” of the voltage to the second deflection regions 132. As a result, the second deflection regions 132 diffract the video light LBS with s-polarization toward the left eye. Accordingly, the video light LBS with s-polarization, which passes through the second deflection regions 132, is also incident to the left eye.

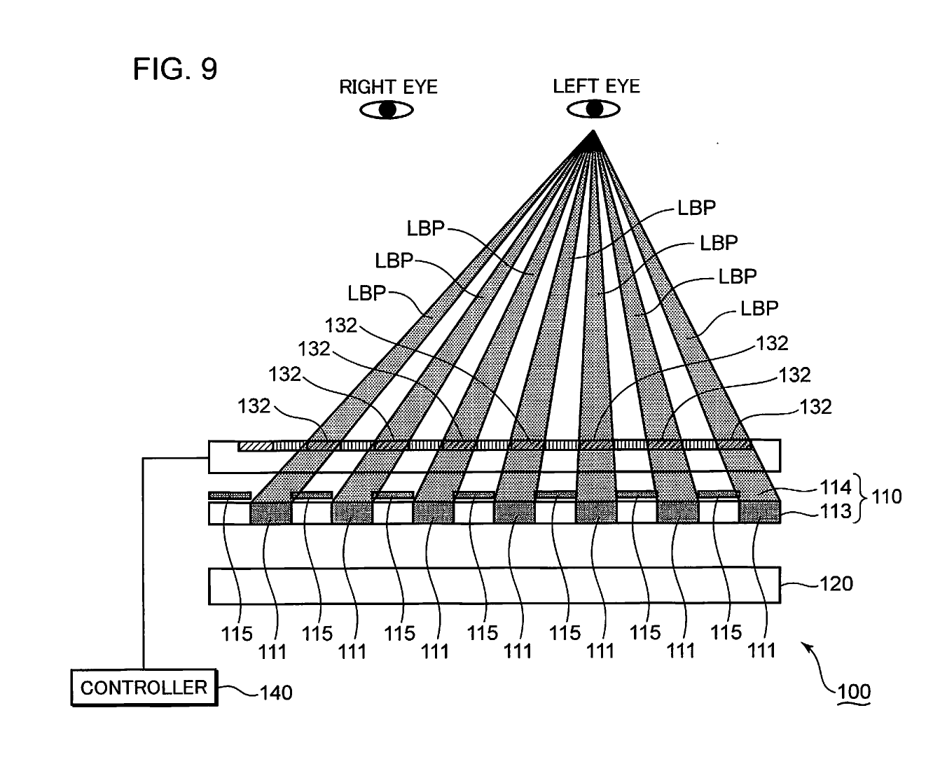

FIG. 9 is a schematic view showing other optical paths of the video light from the image display portion 110, which displays the left frame image. The other optical paths of the video light from the image display portion 110, which displays the left frame image, are described with reference to FIG. 9.

FIG. 9 shows video light LBP of the left frame image, which is emitted from the first pixel regions 111. The video light LBP is incident to the second deflection regions 132 without passing through the polarization rotation devices 115. As aforementioned, the emitting portion 113 outputs the p-polarization of the video light, so that the video light LBP, which is incident to the second deflection regions 132 from the first pixel regions 111, becomes p-polarization.

As aforementioned, the controller 140 applies the magnitude “V2” of the voltage to the second deflection regions 132. Meanwhile, the second deflection regions 132 allow the passage of the video light LBP with p-polarization. Accordingly, the video light LBP with p-polarization linearly travels so that the video light LBP is incident to the left eye.

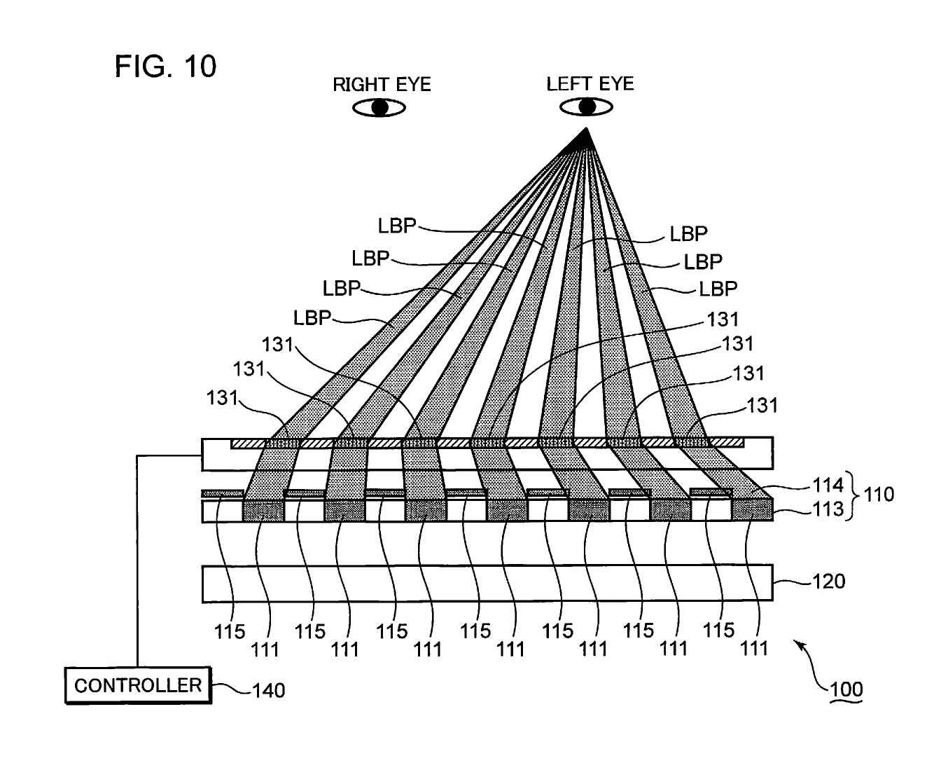

FIG. 10 is a schematic view showing other optical paths of the video light LBP from the image display portion 110, which displays the left frame image. The other optical paths of the video light from the image display portion 110, which displays the left frame image, are described with reference to FIGS. 9 and 10.

As aforementioned, the controller 140 applies the magnitude “V1” of the voltage to the first deflection regions 131. Meanwhile, the first deflection regions 131 diffract the video light LBP with p-polarization toward the left eye. Accordingly, the video light LBP with p-polarization, which passes through the first deflection regions 131, is also incident to the left eye. In the present embodiment, one of the first and second deflection regions 131, 132 are exemplified as the first region. The other of the first and second deflection regions 131, 132 is exemplified as the second region.

In the present embodiment, the holograms layered on the first and second deflection regions 131, 132 exhibit different diffractive properties in response to the polarization of the incident light. As a result, under the control of the controller 140, the video light of the left frame image is generally incident to the left eye whereas the video light of the right frame image is incident to the right eye.

In the present embodiment, the image display portion 110 uses all the pixel regions (the first and second pixel regions 111, 112) to display a frame image. While the left frame image is displayed, the entire video light of the left frame image is incident to the left eye. While the right frame image is displayed, the entire video light of the right frame image is incident to the right eye. Accordingly, the viewer may view a highly luminous video.

The controller 140 may apply a voltage to the first and second deflection regions 131, 132 so that the first and second deflection regions 131, 132 allow both p-polarization and s-polarization to pass through without diffraction. As a result, the display device 100 may appropriately display a two-dimensional video.

As depicted in FIG. 1, the image display portion 110 and the parallax barrier portion 130 are preferably situated within a focal depth of the eyes of the viewer. As a result, the viewer may see a highly luminous video without uncomfortable feeling.

The principles of the present embodiment may be suitably applied to the video display by means of a wideband wavelength of light. For example, if the brazed holograms layered on the first and second deflection regions 131, 132 are provided with gratings corresponding to the wavelengths used for displaying the video, respectively, the video light displayed by the image display portion 110 may be entirely directed to the left or right eye. For example, even if the video is pictured by the three primary colors of red (R), green (G) and blue (B), the brazed holograms layered on the first and second deflection regions 131, 132 are provided with gratings corresponding to these colors, respectively, so that the color components of red, green and blue enter as appropriate to the left or right eye.

A volume hologram may be used instead of the brazed hologram. The display device may exploit wavelength dependency of diffraction efficiency of the volume hologram to display a video with high color purity.

As aforementioned, the display device 100 may suitable display a two-dimensional video in response to the voltage applied to the parallax barrier portion 130 by the controller 140. Meanwhile, the parallax barrier portion 130 allows the video light to pass through regardless of the polarization characteristics of the video light, so that the display device 100 may achieve twice as high resolution as display devices according to the conventional parallax barrier methodology.

The display device may be provided with additional polarization rotation portions and additional deflection regions. As described with reference to FIGS. 3 and 4, while the right frame image is displayed, the video light RBS, which is emitted from the second pixel regions 112, is incident to the first and second deflection regions 131, 132. The additional polarization rotation portions may change the polarization characteristics of the video light RBS, which has been diffracted by the first deflection regions, and the additional deflection regions may then selectively diffract the video light with the adjusted polarization characteristics. If the optical axes of the video light after passage through the first and second deflection regions 131, 132 become substantially coincident with each other due to the additional polarization rotation portions and the additional deflection regions, the viewer may enjoy a high resolution of a video.

The aforementioned embodiment is mainly provided with the following configurations. A display device provided with the following configurations may display a highly luminous stereoscopic video.

A display device according to one aspect of the aforementioned embodiment is provided with an image display portion which temporally switches between a left frame image to be viewed by a left eye and a right frame image to be viewed by a right eye to emit video light so that a video is stereoscopically perceived; a light deflector configured to deflect the video light emitted from the image display portion; and a controller which controls the light deflector to adjust a deflection direction of the video light output from the light deflector, wherein the image display portion changes polarization characteristics of the video light area by area, and the light deflector deflects the video light in response to the polarization characteristics.

According to the aforementioned configuration, the image display portion of the display device temporally switches between the left frame image to be viewed by the left eye, and the right frame image to be viewed by the right eye to output video light so that the video is stereoscopically perceived. Accordingly, the viewer may stereoscopically perceive the video.

The controller of the display device controls the light deflector which deflects the video light emitted from the image display portion to adjust the deflection direction of the video light, which is then output from the light deflector. The image display portion changes the polarization characteristics of the video light area by area. Under control of the controller, the light deflector deflects the video light in response to the polarization characteristics. As a result, the video light of the left frame image is incident to the left eye whereas the video light of the right frame image is incident to the right eye. The video light of the frame images displayed on the image display portion are generally guided as appropriate to the left or right eye, so that the viewer may enjoy a highly luminous video.

In the aforementioned configuration, it is preferable that the image display portion includes a first display area configured to emit the video light as a first polarized light, and a second display area configured to emit the video light as a second polarized light different from the first polarized light, the light deflector includes a first region configured to diffract the first polarized light while one of the left and right frame images is displayed, and a second region configured to diffract the second polarized light while the one frame image is displayed, and while another of the left and right frame images is displayed, the first region diffracts the second polarized light and the second region diffracts the first polarized light.

According to the aforementioned configuration, the first display area of the image display portion emits the video light as the first polarized light. The second display area of the image display portion emits the video light as the second polarized light, which is different from the first polarized light. While one of the left and right frame images is displayed, the first region of the light deflector diffracts the first polarized light and the second region of the light deflector diffracts the second polarized light. While the other of the left and right frame images is displayed, the first region of the light deflector diffracts the second polarized light and the second region of the light deflector diffracts the first polarized light. As a result, the video light of the left frame image is generally incident to the left eye whereas the video light of the right frame image is generally incident to the right eye. The video light of the frame images displayed on the image display portion are generally guided as appropriate to the left or right eye, so that the viewer may enjoy a highly luminous video.

In the aforementioned configuration, it is preferable that while the one of the left and right frame images is displayed, the first region allows the second polarized light to pass through without diffraction, and the second region allows the first polarized light to pass through without diffraction, and while the other of the left and right frame images is displayed, the first region allows the first polarized light to pass through without diffraction, and the second region allows the second polarized light to pass through without diffraction.

According to the aforementioned configuration, while the one of the left and right frame images is displayed, the first region allows the second polarized light to pass through without diffraction, and the second region allows the first polarized light to pass through without diffraction. While the other of the left and right frame images is displayed, the first region allows the first polarized light to pass through without diffraction, and the second region allows the second polarized light to pass through without diffraction. As a result, the video light of the left frame image is incident to the left eye whereas the video light of the right frame image is incident to the right eye. The video light of the frame images displayed on the image display portion are generally guided as appropriate to the left or right eye, so that the viewer may enjoy a highly luminous video.

In the aforementioned configuration, it is preferable that the second display area includes a polarization rotation portion which rotates a polarization direction of the first polarized light to generate the second polarized light.

According to the aforementioned configuration, the polarization rotation portion of the second display area rotates the polarization direction of the first polarized light to generate the second polarized light. As a result, the second display area may appropriately emit the video light of the second polarized light.

In the aforementioned configuration, it is preferable that the polarization rotation portion includes polarization rotation elements configured to generate the second polarized light from the first polarized light, and the polarization rotation elements are discretely and horizontally aligned.

According to the aforementioned configuration, the polarization rotation portion includes polarization rotation elements configured to generate the second polarized light from the first polarized light. The polarization rotation elements are discretely and horizontally aligned, so that the second display areas may emit the video light of the second polarized light which is discretely and horizontally aligned.

In the aforementioned configuration it is preferable that intervals between the polarization rotation elements are consistent.

According to the aforementioned configuration, the intervals between the polarization rotation elements are consistent, so that the intervals of the second polarized light of the video light become consistent.

### INDUSTRIAL APPLICABILITY

The principles according to the aforementioned embodiment change the polarization characteristics of the parallax barrier in synchronism with the display timings of the left and right frame images. As a result, the video light of the left and right frame images is efficiently transmitted to the left and right eyes, respectively. The switching operation between the left and right frame images is achieved temporally rather than spatially. Accordingly, a highly luminous video is displayed. Thus, the principles of the aforementioned embodiments may be preferably applied to display devices which display a stereoscopic video by means of the parallax barrier methodology.

What is claimed is:

1. A display device, comprising:
an image display portion which temporally switches between a left frame image to be viewed by a left eye and a right frame image to be viewed by a right eye to emit video light so that a video is stereoscopically perceived;
a light deflector configured to deflect the video light emitted from the image display portion; and
a controller which controls the light deflector to adjust a deflection direction of the video light output from the light deflector,
wherein the image display portion changes polarization characteristics of the video light area by area, and
the light deflector deflects the video light in response to the polarization characteristics.

2. The display device according to claim 1,
wherein the image display portion includes a first display area configured to emit the video light as a first polarized light, and a second display area configured to emit the video light as a second polarized light different from the first polarized light,
the light deflector includes a first region configured to diffract the first polarized light while one of the left and right frame images is displayed, and a second region configured to diffract the second polarized light while the one frame image is displayed, and
while another of the left and right frame images is displayed, the first region diffracts the second polarized light and the second region diffracts the first polarized light.

3. The display device according to claim 2,
wherein while the one of the left and right frame images is displayed, the first region allows the second polarized light to pass through without diffraction, and the second region allows the first polarized light to pass through without diffraction, and
while the other of the left and right frame images is displayed, the first region allows the first polarized light to pass through without diffraction, and the second region allows the second polarized light to pass through without diffraction.

4. The display device according to claim 2,
wherein the second display area includes a polarization rotation portion which rotates a polarization direction of the first polarized light to generate the second polarized light.

5. The display device according to claim 4,
wherein the polarization rotation portion includes polarization rotation elements configured to generate the second polarized light from the first polarized light, and
the polarization rotation elements are discretely and horizontally aligned.

6. The display device according to claim 5,
wherein intervals between the polarization rotation elements are consistent.
